(19) United States
(12) Patent Application Publication
(10) Pub. No.: US 2019/0369294 A1
(43) Pub. Date: Dec. 5, 2019

(54) ENHANCING OPTICAL TRANSMISSION OF MULTLAYER COMPOSITES WITH INTERFACIAL NANOSTRUCTURES

(71) Applicant: North Carolina State University, Raleigh, NC (US)

(72) Inventors: Chih-Hao Chang, Raleigh, NC (US); Sharan V. Naidu, Raleigh, NC (US); Yi-An Chen, Raleigh, NC (US)

(21) Appl. No.: 16/425,035

(22) Filed: May 29, 2019

Related U.S. Application Data
(60) Provisional application No. 62/677,362, filed on May 29, 2018.

(51) Int. Cl. G02B 1/118; G02B 1/115; G02B 1/111

(52) U.S. Cl. CPC G02B 1/118; G02B 1/111; G02B 1/115

(57) ABSTRACT

Various examples related to multilayer nanostructures, methods of making, and applications are provided. In one example, a multilayer nanostructure includes layers that include a substrate having a first surface and a second surface; and tapered nanostructures on the first surface and the second surface of the substrate. Adjacent layers of the layers can be bonded together by a bonding material, forming a multilayer composite material having tapered nanostructures embedded at each interface between the adjacent layers and the bonding material. In another example, a method of making multilayer nanostructures includes patterning a substrate surface with an antireflection coating and a polymer; etching the polymer to form tapered nanostructures on the surface to form a first layer; bonding the first layer to a second layer comprising tapered nanostructures on a substrate surface with a bonding material to form a multilayer composite material.

### CROSS REFERENCE TO RELATED APPLICATIONS

This application claims priority to, and the benefit of, co-pending U.S. provisional application entitled “Enhancing Optical Transmission of Multilayer Composites with Interfacial Nanostructures” having Ser. No. 62/677,362, filed May 29, 2018, which is hereby incorporated by reference in its entirety.

### STATEMENT REGARDING FEDERALLY SPONSORED RESEARCH OR DEVELOPMENT

This invention was made with government support under grant number W911NF-16-1-0314 awarded by the U.S. Army's Army Research Office and grant number 1552424 awarded by the National Science Foundation. The government has certain rights in the invention.

### BACKGROUND

In recent years, bioinspired nanomaterials and nanostructures have drawn increasing interest because of their novel electrical, optical, or mechanical behaviors. One example is the antireflection (AR) nanostructure, which is inspired by the moth eye. Such a bio-inspired nanostructure has demonstrated antireflection effects on material surfaces over broadband and wide-angle illumination, which is advantageous over traditional AR coating. This surface reflection may be attributed to the refractive index mismatch at the air-solid interface between two different materials, which causes Fresnel reflection losses and reduces transmission.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1D illustrate reflection and scattering losses, in accordance with various embodiments of the present disclosure.

FIGS. 2A, 2B and 2C are plots illustrating examples of antireflection effects with various incident angles, nanostructure heights, and number of planar and nanostructured interfaces, in accordance with various embodiments of the present disclosure.

FIGS. 3A and 3B illustrate a comparison of transmission and iridescence contrast between the planar and nanostructured interfaces, in accordance with various embodiments of the present disclosure.

FIGS. 4A and 4B illustrate examples of two-dimensional (2D) contour plots of a simulated example of total reflection efficiency (R_{T}) at a nanostructured interface, in accordance with various embodiments of the present disclosure.

FIGS. 5A-5F illustrate an example of forming interfacial nanostructures on a substrate for bonding a multilayer stack, in accordance with various embodiments of the present disclosure.

FIG. 6A illustrates an example of bonding a multilayer stack with nanostructured interfaces using an ultraviolet (UV)-curable polymer, in accordance with various embodiments of the present disclosure.

FIGS. 6B-6D are scanning electron microscope (SEM) images of tapered nanostructures on a surface, in accordance with various embodiments of the present disclosure.

FIG. 7 are SEM images of a fabricated nanostructured interface, in accordance with various embodiments of the present disclosure.

FIGS. 8A and 8B are plots illustrating examples of transmission with respect to incident angle for a 1-layer fused silica sample under transverse-electric (TE) and transverse-magnetic (TM) modes, in accordance with various embodiments of the present disclosure.

FIGS. 8C and 8D are plots illustrating transmission with respect to incident angle for a 3-layer fused silica sample under TE and TM modes, in accordance with various embodiments of the present disclosure.

FIGS. 9A and 9B are plots illustrating examples of broadband measurement data for substrates with nanostructured and planar interfaces, in accordance with various embodiments of the present disclosure.

FIG. 10 is a plot illustrating an example of measured interference contrast for substrates with nanostructured and planar interfaces, in accordance with various embodiments of the present disclosure.

FIGS. 11A-15B are plots illustrating examples of measurement and simulation data for multilayer substrates, in accordance with various embodiments of the present disclosure.

### DETAILED DESCRIPTION

Disclosed herein are various embodiments related to multilayer nanostructures, methods of making, and applications. For example, structures related to multilayer composite materials having tapered nanostructures embedded at each interface between layers are disclosed. The nanostructures can serve as a gradient-index medium where its effective index bridges that index mismatch. Reference will now be made in detail to the description of the embodiments as illustrated in the drawings, wherein like reference numbers indicate like parts throughout the several views.

Engineered surfaces with an antireflection (AR) nanostructure have been demonstrated using electron-beam lithography, interference lithography, colloidal assembly, and maskless reactive ion etching and can be implemented to effectively suppress surface reflections. Oblique-angle deposition of single and multilayer films with varying porosity can also be effective in emulating a gradient-index medium. Beyond reducing reflection, nanostructures can also be tuned to enhance the surface absorptivity. These advances have many applications in photonics and optoelectronics, such as optical micro-resonators, improving the efficiency or performance of solar cells, enhancing light extraction in light emitting devices such as solid-state lighting, and enabling anti-glare, self-cleaning windows for displays.

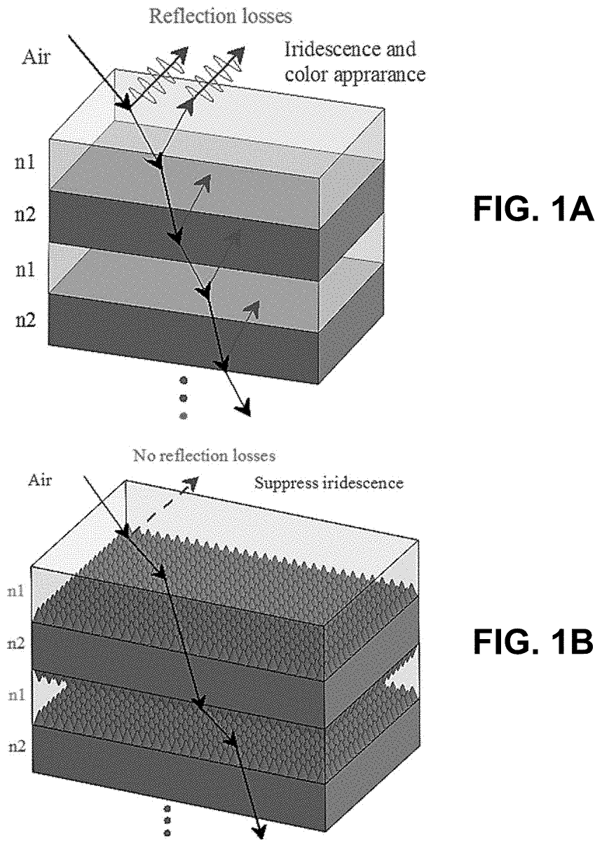

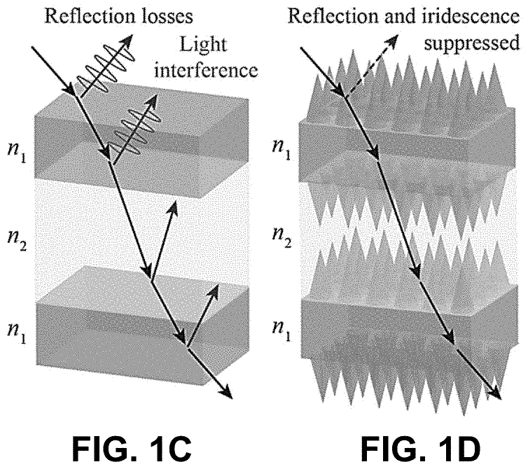

While most AR nanostructures have been focused on material surfaces, Fresnel losses can also occur between two solid materials. In such multilayer composites and multilayer thin films, multiple interfacial reflections need to be considered. Referring to FIG. 1A, shown is a schematic representation illustrating the reflection and scattering losses due to the refractive index mismatch at the interface in a multilayer film. These reflections in the multilayer film can interfere and induce iridescent effects, which can lead to transmission losses and wavelength/angle-dependent behavior in devices with multilayer stacks. These effects are especially problematic at wider viewing angles, thus there is a need to reduce reflection losses, increase transmission, and/or suppress iridescence.

Under coherent illumination, such reflections can interfere and induce iridescent effects. This can lead to wavelength and angle-dependent properties, which is undesirable in broadband optical element and devices. This optical effect can be observed in nacre, which is constructed from alternating microscale laminates of stiff and soft materials. Due to the difference in refractive indices, reflection losses between the layers interfere and give rise to the iridescent appearance. While the brilliant color can be visually pleasing, it would lead to an undesirable tinted appearance when the layered architecture is used for transparent substrates. Therefore, the ability to reduce interfacial reflection losses and interference effect is beneficial for applications such as, e.g., transparent armor.

These losses may be mitigated considerably if the discontinuity in refractive index can be replaced by an effective medium with continuously changing index. Tapered nanostructures offer an effective method to emulate such a medium, and can reduce reflection losses, increase transmission, and/or suppress iridescence. This can mitigate wavelength/angle-dependence and enhance broadband transmission in the multilayer structures. FIG. 1B illustrates the effect of interfacial nanostructures in reducing the reflection losses and suppress the iridescence.

It can be demonstrated that the interfacial reflection between a polymer film and silicon substrate can be suppressed using nanostructures by studying the reflectance spectra, however the more complex phenomenon of reflections from multiple interfaces have not been considered. How the suppression of interfacial reflection affects the broadband transmission remains unanswered. This can be important when considering that reducing light reflection does not necessarily lead to enhanced transmission, since the specular transmitted order can have losses due to light scattering from fabrication defects in the multilayer interfaces. The Fresnel losses and light interference in multilayer films with alternating materials having planar interfaces are illustrated in FIG. 1C, where reflected orders at each interface can interfere. These losses can be mitigated by introducing tapered nanostructures at the interfaces, as illustrated in FIG. 1D. The structures emulate an effective medium with continuously changing index and bridges the neighboring refractive indices. These interfacial nanostructures can reduce the reflections at the interfaces, thereby suppressing iridescent effects induced by interference and increasing light transmission.

The present disclosure describes the design and fabrication for interfacial nanostructures (e.g., tapered nanostructures or nanocones) in multilayer materials to enhance transmission and/or suppress interference effects. Embodiments of the present disclosure provide for a multilayer nanostructure, including a plurality of layers. Nanostructure layers can include a substrate having a first surface and a second surface. The substrate can comprise material such as, but not limited to, silica and sapphire. For example, the substrate can be Si, Ge, GaAs, or other material or combination of materials which can be used in, e.g., LEDs or OLEDs (e.g., dielectric, semiconductor, oxides, metal, etc.). Tapered nanostructures can be formed on the first surface and the second surface of the substrate. The nanostructures can be etched or fused onto the surface, or fabricated using for example nanoimprinting, surface ablation, or other appropriate process. The individual nanostructure layers can be bonded together using a polymer or other appropriate bonding material (e.g., inorganic, dielectric, semiconductor, metal, etc.) to form a multilayer composite material. For example, a polymer based optical adhesive (OA) can be used to form a multilayer composite material having tapered nanostructures embedded at each interface between layers. Demonstrated are the structure geometry, namely the height, period, and profile that can minimize interfacial reflection and realize the optical transmission enhancement in multilayer composites with interfacial nanostructures. Various structure shapes can be used, such as linear, quadratic, quintic, Gaussian, Chebyshev, etc., which determines the effective index profile. Additional discussion regarding nanostructure geometries at a material surface is provided in, e.g., “Optimal design for antireflective tapered two-dimensional subwavelength grating structures” by Grann et al. (J. Opt. Soc. Am. A, vol. 12, no. 2, pp. 333-339, Februar 1995), “Optimal broadband antireflective taper” by Zhang et al. (Opt. Lett., vol. 38, no. 5, pp. 646-8, March 2013), and “Antireflection effects at nanostructured material interfaces and the suppression of thin-film interference” by Yang et al. (Nanaotechnology, vol. 24, No. 23, 235202, June 2013), each of these three publications are hereby incorporated by reference in their entireties.

This model is based on rigorous coupled-wave analysis (RCWA), where the tapered nanostructures are approximated by discrete two-dimensional (2D) gratings with varying duty cycles. A Lloyd's mirror interference lithography set up is used to create a 2D pillar array in photoresist, which can be transferred to the underlying substrate using CHF3 reactive ion etching (RIE). The nanostructures can be patterned on both sides and bonded with UV-curable epoxy to form a multilayer stack with nanostructured interfaces. The wide-angle and broadband optical performance of these structures are presented.

In various embodiments, the tapered nanostructures have a period of about 200 nm to about 400 nm and a height of about 300 nm to about 1000 nm. The structure period and height depend on the wavelength band that the structure is designed for. A general guideline is that the period should be about half of the shortest wavelength, and the height should be at least half of the longest wavelength range. For example, the structure period for a mid-infrared wavelength can be about 1 μm, with a height of about 3 μm or more.

Experimental demonstration of interfacial nanostructures in multilayer thin and thick films to suppress interference effects and enhance broadband transmission is presented. As will be discussed, structures were fabricated on fused silica substrates, which served as a template to create a nanostructured interface by infiltration using different polymer types and thicknesses. A substrate bonding process was used to stack and assemble multiple double-side patterned fused silica substrates, and a thick multilayer composite material comprising three silica and two polymer layers was fabricated. The wide-angle and broadband optical performance of these structures were characterized and demonstrate suppressed iridescence and enhanced transmission. The experimental data agree well with constructed simulation models based on rigorous coupled-wave analysis (RCWA) methods. The results demonstrate that interfacial nanostructures are an effective method to mitigate wavelength and angle-dependent behavior and enhance broadband transmission in multilayer devices and composite materials.

### Multilayer Design

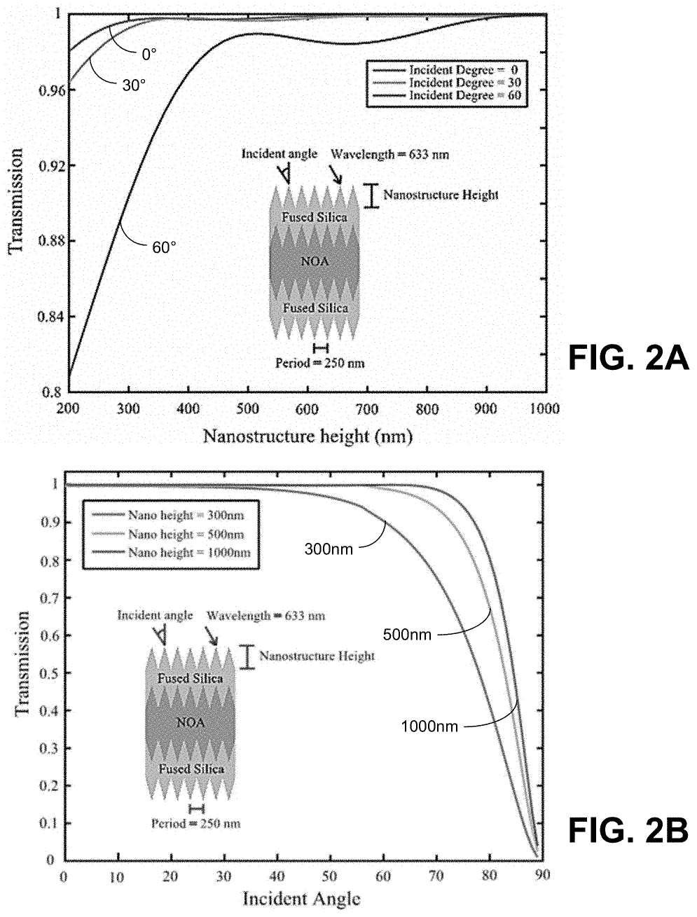

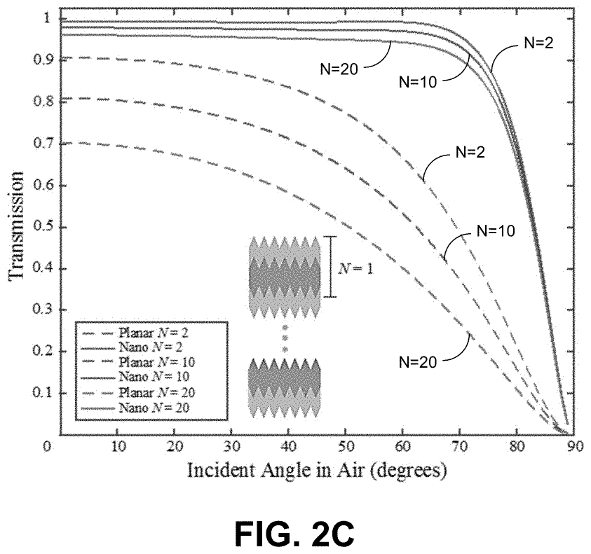

Examples of the multilayer composites with interfacial nanostructures were modeled using rigorous coupled-wave analysis (RCWA). The RCWA model was based on alternating polymer (n_{poly}=1.70) and fused silica (n_{fs}=1.45) layers periodic along both x and y directions. The tapered nanostructures were approximated by discrete two-dimensional gratings with a 250 nm period and varying duty cycles. The light was incident at various angles, with a 633 nm wavelength. Both transverse-electric (TE) and transverse-magnetic (TM) polarizations were considered. FIGS. 2A-2C are plots illustrating examples of transmission with respect to nanostructure height, incident angle and incident angle in air, respectively.

Preliminary design results are illustrated in FIG. 2A, where the transmission of a multilayered stack with alternating polymer layers is plotted versus total height of the interfacial nanostructures. In FIG. 2A, the antireflection effect is considered with varying nanostructure heights. Three curves are provided for different incident angles of 0°, 30° and 60°. The results show that higher nanostructures lead to higher transmission, because the refractive index of the interfacial materials changes smoothly. Also, the transmission can approach 1 (unity) as the structure height approaches the incident wavelength of 633 nm. In FIG. 2B, the antireflection effect is considered with varying incident light angles. From the plot of FIG. 2B, it can be seen that transmission drops down at the higher incident angles. The RCWA simulation results in FIGS. 2A and 2B indicate that using multilayer composites with interfacial nanostructures can lead to almost perfect optical transmission if well designed interfacial nanostructures are fabricated. The enhancement can be dramatic for periodic multilayer stacks. FIG. 2C depicts the transmission for N stacks (of pairs of polymer and fused silica layers) with and without interfacial nanostructures (500 nm tall). The plot shows the simulated transmission versus incident angle for the planar and nanostructured interfaces. It can be observed that the presence of interfacial nanostructures results in low transmission degradation regardless of number of layers.

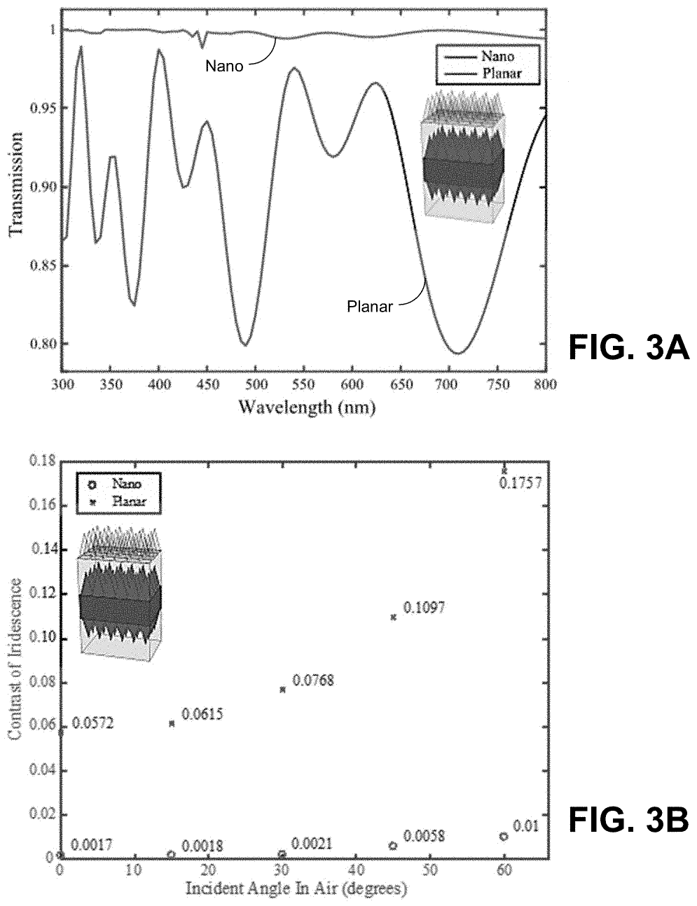

Furthermore, the reduction of interfacial reflection can also suppress iridescence due to interference effects. FIG. 3A illustrates a transmission comparison between the planar and nanostructured interfaces. The broadband transmission of a polymer/oxide/polymer stack (in this example, each layer is 600 nm tall) with and without interfacial nanostructures is shown. Strong intensity oscillations can be observed for the planar interface samples, which is heavily suppressed by the nanostructures. Broadband transmittance (UV-NIR) simulation indicates that the iridescence can be mitigated in the multilayer structure with nanostructured interfaces. FIG. 3B illustrates an iridescence contrast comparison between the planar and nanostructured interfaces. Comparing the interference contrast shows significant improvement especially at high incident angles. The iridescence contrast (visibility) can be suppressed significantly at a wide range of viewing angles (0-60°). Under normal incident angles, the iridescence contrast value of the sample with interfacial nanostructures is only one-third of the sample without interfacial nanostructures. When the incident angle is increased, the iridescence contrast different between sample with and without interfacial nanostructure become even larger.

The RCWA simulation results in FIGS. 2A-2C and 3A-3B indicate tapered nanostructures are an effective method to emulate such a medium, and can reduce reflection losses, increase transmission, and suppress iridescence. This can mitigate wavelength/angle-dependence and enhance transmission in multilayers. The optimal structure geometry can be determined to minimize interfacial reflection and realize the optical transmission enhancement in multilayer composites with interfacial nanostructure.

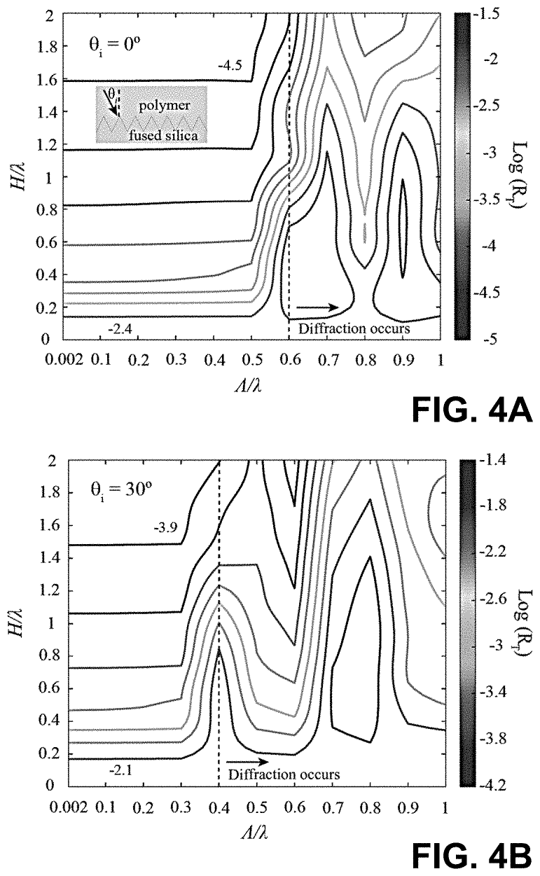

In addition, the polymer and silica assumed to be semi-infinite media to study the reflection efficiency at the interface. Here, interfacial nanostructures with a linear taper profile were approximated by discrete 2D gratings with a square lattice and varying duty cycles from 0 to 1. Examples of the simulated total reflection efficiencies (R_{T}) at the polymer-to-silica interface (n_{poly}=1.70 and n_{fs}=1.45) are shown as 2D contour plots using log scales in FIGS. 4A and 4B. The x-axis and y-axis are normalized nanostructure period (A/λ) and height (H/λ), respectively. In FIG. 4A, the reflection is plotted versus normalized structure height and period at an incident angle of θᵢ=0°, and in FIG. 4B at an incident angle of θᵢ=30°. Note that the total reflection efficiency can include reflected diffracted orders for structures with larger periods.

The reflection efficiency of a planar polymer-to-silica interface is 0.63% (−2.2 in log scale) at normal incidence, corresponding to H=0 in FIG. 4A. However, for a structure height H=2 λ and period A=0.5 λ, the reflection efficiency can be decreased to 0.0021% (−4.7 in log scale). In this case, the interfacial nanostructures reduce the reflection loss by a factor of 300. For slightly shorter structures H=0.6 λ with the same period, the reflection efficiency can be reduced to 0.027% (−3.6 in log scale), roughly a 23-fold improvement over planar interface. For larger incident angles θᵢ=30°, the reflection efficiency of a planar polymer-to-silica interface is slightly higher at 1.26% (−1.9 in log scale), as shown in FIG. 4B. The reflection efficiency can be reduced to 0.15% (−2.8 in log scale) for a structure height H=0.6 λ and period A=0.5 λ. The reflection efficiency can be further eliminated to 0.030% (−3.5 in log scale) for a nanostructure height H=2 λ with the same period. Note that while the reflection losses at a single interface between polymer and silica is generally low, it can be compounded for multiple layers. In addition, the reflection losses would be significantly higher for interfaces with higher index contrast.

It can be observed that the AR effect is stronger for taller interfacial nanostructures, which is expected since this creates a medium with a lower index gradient. For a larger nanostructure period, the reflection efficiency increases and results in intensity oscillation. This may be attributed to diffraction orders being no longer evanescent, as marked by the dashed line in FIGS. 4A and 4B, resulting in the interfacial nanostructures not in subwavelength operation. The first-order diffraction becomes a propagating mode when the structure period around A=0.6 λ and A=0.4 λ for incident angles θᵢ=0° and θᵢ=30°, respectively. It is also interesting to note that while the structure period has to be subwavelength, having a much smaller period does not greatly reduce reflection losses. The same can be said for structure height, which results in lower reflection but the improvement is incremental. Based on this analysis, a nanostructure with 250 nm period and 400 nm height was considered, as it was expected to exhibit a strong interfacial AR effect in the visible spectrum.

### Fabrication Method and Materials

Next, a method of making multilayer nanostructures is discussed. In various embodiments, the method can comprise: patterning a substrate (e.g., silica or sapphire) with an antireflection coating and a thin film polymer; etching the polymer to form tapered nanostructures on both sides of the silica substrate to form a layer; bonding a plurality of layers with a bonding material (e.g., a polymer or an optical adhesive) to form a multilayer composite material having tapered nanostructures embedded at each interface between layers. The proposed interfacial nanostructures are demonstrated in a composite multilayer with alternating polymer and fused silica layers.

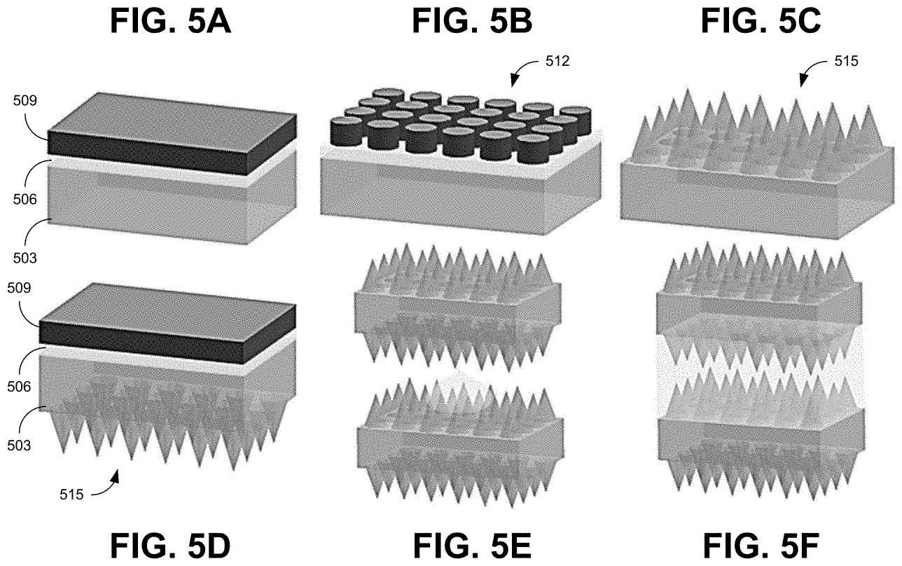

For example, the interfacial nanostructures (or tapered nanostructures) can be implemented in a polymer/fused silica composite and can be fabricated using a combination of interference lithography (IL), reactive ion etching (RIE), and substrate stacking. First, a fused silica substrate 503 can be spin coated with an antireflection coating (ARC) 506 (e.g., 13 nm of ARC; Brewer Science i-con-7) and photoresist 509 (e.g., 250 nm of Sumitomo PFI-88A2), as shown in FIG. 5A. Other types of photoresist and/or ARC coatings can be used to create the nanostructure pattern. The ARC coating 506 is used to reduce reflection from the substrate during lithography. Two orthogonal exposures using a Lloyd's mirror IL setup can create a 2D pillar array 512 in the photoresist 509, as illustrated in FIG. 5B, which can then be transferred to the underlying silica substrate 503 using O₂ and CHF₃ reactive ion etching (RIE). The pillar array 512 can have a period of, e.g., 250 nm. The photoresist mask 512 can also be etched during the process, yielding the tapered profile nanostructures 515 as illustrated in FIG. 5C.

A second thin film polymer (e.g., ProTEK® B3-25, Brewer Science) can then be spin coated on the front-side nanostructures 515, and the same process can be repeated to pattern the backside of the silica substrate, as shown in FIG. 5D. After the backside patterning, the second film can be removed using a solvent solution (e.g., ProTEK® Remover 100, Brewer Science) followed by an O₂ plasma etch, resulting in a fused silica substrate 503 with subwavelength AR structures 515 patterned on both sides. Materials other than thin film polymers can be used, such as oxides or other transparent materials, as can be envisioned by one skilled in the art. Multiple interfacial nanostructures can be produced using this method. In one implementation, the period and height of the nanostructures described herein were nominally 250 nm and 400 nm, respectively. Other periods and heights are also possible. For example, tapered nanostructures with a period in a range from about 110 nm to about 2000 nm can be fabricated using this method, and heights as tall as 2000 nm can be achieved using more complex etch mask designs.

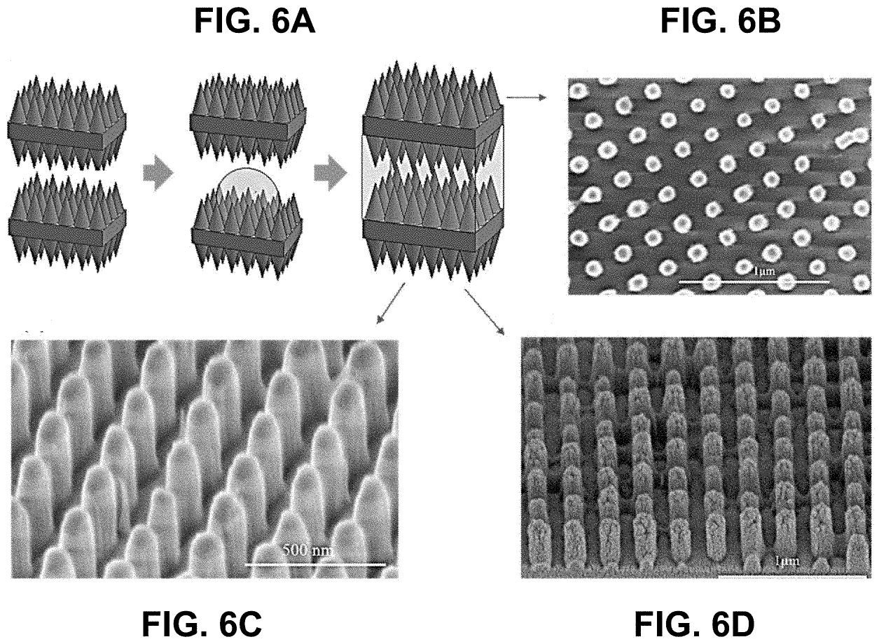

The double-side patterned fused silica substrates can then be bonded using a UV-curable epoxy disposed between the substrates, as depicted in FIG. 5E, which is then cured using UV light with low intensity to reduce bubble formation. The thickness of the epoxy can be in the order of, e.g., 0.1 mm. This process can be repeated to construct a thick multilayer silica/polymer composite material with nanostructures embedded at each interface, as shown in FIG. 5F. Bonding of the double-side patterned fused silica substrates in FIGS. 5E and 5F may be better seen in FIG. 6A.

FIG. 6A shows an example of bonding of the multilayer stack with nanostructured interfaces using, e.g., an optical adhesive. In some embodiments, the optical adhesive can be a UV-curable optical adhesive (e.g., NOA 170, Norland Optical Adhesive). As shown in FIG. 6A, the layers are positioned and the optical adhesive is deposited between the layers. Curing of the optical adhesive fills in the voids between the interfacial nanostructures of the adjacent layers. It was found that fast curing under strong UV light can produce large bubbles in the adhesive. Therefore, slow curing was performed by a high-intensity illuminator (e.g., MI-150, Edmund Optics) for 1 hour. Only few and small bubbles were found after the slow curing of the optical adhesives was completed. In some implementations, a thin film polymer can be etched onto the nanostructures prior to bonding the plurality of layers. This process can be repeated to construct a multilayer silica/polymer composite material, with nanostructure embedded at each interface. The structures on opposite surfaces of a substrate, or on facing surfaces of adjacent substrates in the stack, can be aligned with each other, or may be misaligned. Since the nanostructure are subwavelength and emulate an effective medium, precise alignment is not necessary.

FIGS. 6B-6C are scanning electron microscope (SEM) images showing an example of the fabricated fused silica nanostructure. FIG. 6B shows a top view of the tapered nanostructures on the first surface of the substrate, FIG. 6C shows a perspective view of the tapered nanostructures on the first surface, and FIG. 6D shows a cross-sectional view of the tapered nanostructures on the first surface. The fidelity SEM pictures illustrate that the interfacial nanostructures are well arranged with a 250 nm period and with only a few defects. Then NOA 170 (Norland Optical Adhesive), which is a UV-curable optical adhesive, was applied to the two interfaces between the fused silica samples for bonding. In one implementation, three fused silica substrates, each 0.5 mm thick, were bonded to yield a silica-polymer-silica-polymer-silica composite. Note that each layer in the composite material is relatively thick compared to the coherent length of ambient light or broadband lamps, meaning that no interference is expected so that the transmission enhancement can be better quantified.

This fabrication process was also used to pattern a thin single-layer polymer sample to examine the effect of thin-film interference on the broadband transmittance. These samples included tapered nanostructures patterned on the front side of the fused silica substrate. A thin layer of photoresist (Sumitomo PFI-88) around 750 nm thick was then spin coated on top of fused silica nanostructures. The back side of the substrate was polished but not patterned. These samples comprised a nanostructured polymer-silica interface, while the top polymer and bottom fused silica surfaces are planar. Here the film thickness was less than the coherent length of the spectrophotometer light source, allowing the study of interfacial reflection by quantifying the thin-film interference effects. Note these samples served a different purpose to the thick multilayer samples described above, which included tapered nanostructures on both sides for transmission characterization.

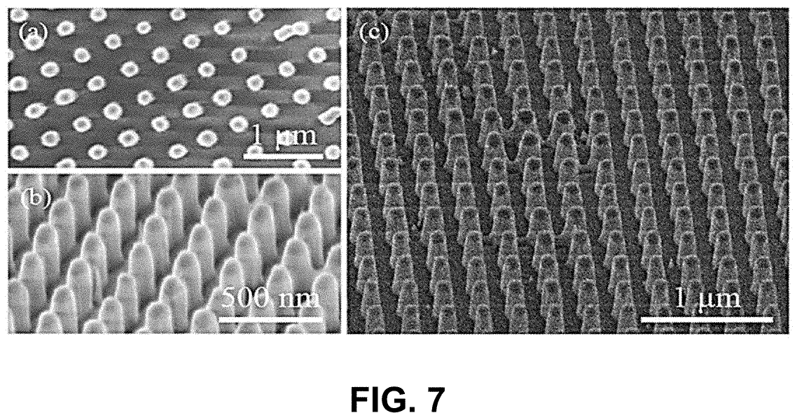

Scanning electron microscope (SEM) images of the fabricated nanostructures on the front of the fused silica substrate are shown in FIG. 7. The top view of 2D pillar array in photoresist after IL exposure is shown in image (a) of FIG. 7, indicating the periodic order in a square lattice. A few photoresist structure collapses can be seen. The side-view SEM of AR nanostructures etched into the fused silica substrate are shown in images (b) and (c) of FIG. 7. The conic profile of the structure can be observed in the higher magnification image shown in image (b) of FIG. 7. The large-area uniformity is illustrated in image (c) in FIG. 7, with some defects due to residual connection between the structures. Some nanoscale spikes can also be observed, and can be attributed to redeposition of the volatile species during RIE. These results illustrate that the AR nanostructures are well arranged with 250 nm period and around 400 nm height, as desired. Few defects as a result of collapsed resist and surface roughness can be observed. The SEM images of the back-side structures indicate similar structure geometry and quality.

The optical properties of the thin and thick multilayer stacks with interfacial nanostructures are modeled using RCWA, where the tapered nanostructures are approximated by discrete 2D gratings with varying duty cycles. The RCWA model is based on alternating fused silica (n_{fs}=1.45) and polymer (n_{poly}=1.70) layers periodic along both x and y directions. The nanostructures model can be approximated as a square lattice with 250 nm period. Theoretical models for three types of structure at the interface have been constructed to validate experimental results and evaluate the effectiveness of the interfacial nanostructures. The first is a planar model comprising a continuous polymer film on fused silica substrate layers with no nanostructures. The second describes the fabricated samples with the nanostructured interface. The structure geometry and profile were obtained from the SEM images to accurately simulate the fabricated structure shape. The modeled structure has a 400 nm height and 0 to 0.6 duty cycle. Note that the fabricate structure height and profile were not optimized for AR performance, and taller structures with a 700 to 800 nm height with more effective tapered profile can be achieved using a different etching mask. The third model comprises theoretical structures with a 750 nm height and a linear tapered profile from 0 to 1 duty cycle, which describes the performance that can be obtained for more optimized structure geometry.

### Experimental Results

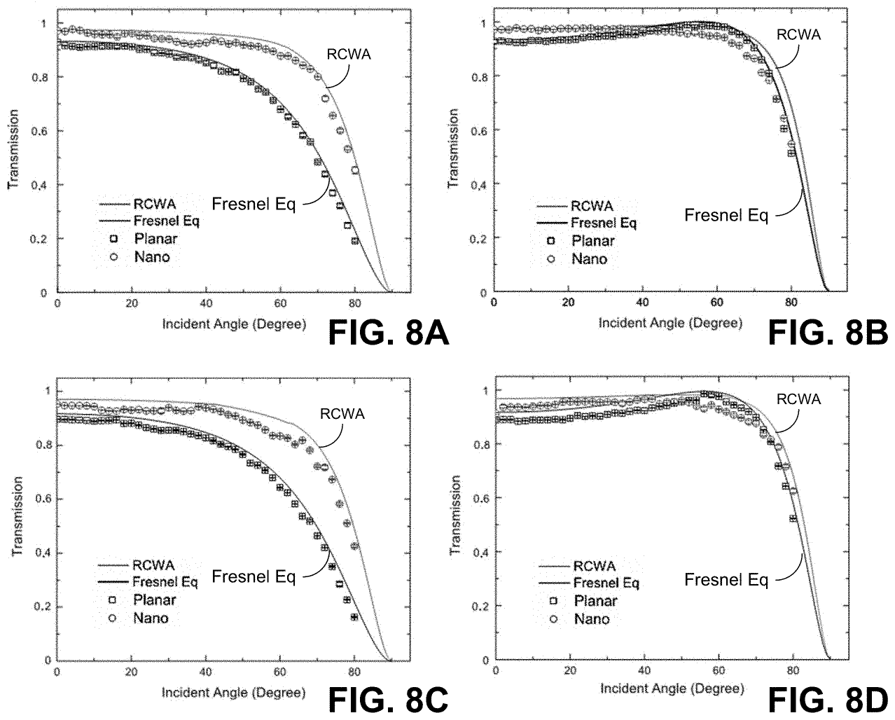

The optical transmission of the prepared samples was measured by using a 633 nm HeNe laser (Model 30995, Research Electro-Optics, Inc.). A rotation stage (RSP-1T, Newport Co.) was used to rotate the sample to change incident angles from 0° to 70° with 1° resolution. For incident angles larger than 70°, the illumination area exceeded the area of the nanolattice material, and therefore, those angles are not considered. A photodiode detector (Model 918D-UV-OD3, Newport Co.) was used to measure the transmitted light intensity. The transmission for both TE and TM polarizations was characterized. The transmission measurements and theoretical calculation results of fused silica with double sides nanostructures for 633 nm wavelengths and both TE and TM polarization states are plotted in FIGS. 8A-8D. This offers a direct comparison to theoretical models that were based on the three-layer approximation.

FIGS. 8A and 8B show the measured transmission versus incident angle of the 633 nm laser for a 1-layer fused silica sample under TE mode and under TM mode, respectively. As can be seen in FIGS. 8A and 8B, the experimental results agree with the RCWA and Fresnel equation theoretical models. The transmission is enhanced by about 5% near a 0° incident angle, and up to 10-20% in a 60° -70° incident angle range under the TE mode. This result indicates that the tapered nanostructures offer an effective method to emulate such a medium, and can reduce reflection losses and increase transmission. However, under TM model in a 50°-70° incident angle range, the optical transmission of sample with the nanostructures was not as good as the sample without nanostructures. This may be attributed to the Brewster angle effect, where the transmission for the planar interface experiences 100% transmission.

FIGS. 8C and 8D show the measured transmission versus incident angle of the 633 nm laser for a 3-layer fused silica sample bonded using NOA 170 under TE mode and under TM mode, respectively. For the multilayer composites in FIGS. 8C and 8D, the experiment results show the transmission is enhanced by about 10% near a 0° incident angle, and up to 20-30% in a 60° -70° incident angle range under TE mode. These results and the derived model indicate that by using interfacial nanostructures, the reflection between two materials can be heavily suppressed. This effect in turn suppresses thin film interference, allowing for angle-independent optical behavior. For better interfacial antireflection effects than those demonstrated, taller structures with an optimal taper profile can be used.

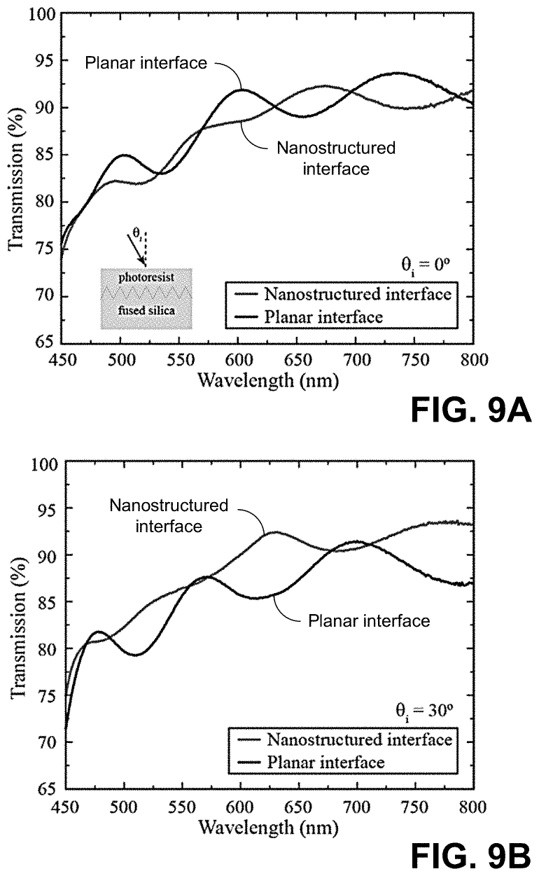

The fused silica substrate with a thin photoresist film was characterized to study the thin-film interference effects. The broadband transmittance of the thin-film sample with planar and nanostructured interfaces were measured using a UV-visible-NIR spectrophotometer (e.g., Cary 5000, Agilent Co.). FIGS. 9A and 9B show the broadband measurement data for thin polymer film on fused silica substrates with nanostructured and planar interfaces. The film is a layer of photoresist with 750 nm thickness. The transmittance measurements from 450 to 800 nm wavelength for incident angles θᵢ=0° and θᵢ=30° are shown in FIGS. 9A and 9B, respectively. Intensity oscillations can be observed in all of the measurements, which is characteristic of interference effects. This is due to reflections from the polymer surface and the polymer-silica interface, which leads to two-beam interference. At an incident angle of θᵢ=0°, the transmission enhancement for the nanostructured interface is not obvious, as shown in FIG. 9A. However, the intensity oscillation is reduced. This may be attributed to the reduction of reflection at the polymer-silica interface by the nanostructures, thereby suppressing interference effects. The transmittance measurement for incident angle θᵢ=30° shows an average of 5% transmission enhancement for the sample with the interfacial nanostructures, as shown in FIG. 9B. The intensity oscillation has also been reduced. These results indicate that the sample with nanostructured interface has higher light transmission and less intensity oscillation due to interference effects.

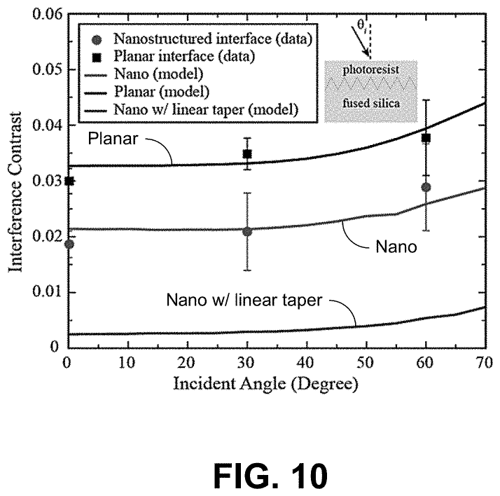

The interference contrast, or the ratio of the sinusoidal intensity amplitude to the average intensity, can be calculated to quantify the suppression of the thin-film interference effects. The contrast describes the degree of interference for the reflected orders, and approaches zero as the interfacial reflection is suppressed. The contrast values can be determined by first fitting the broadband transmittance data using a second order polynomial to estimate the average intensity. The difference between the data and the average intensity can then be calculated to approximate the sinusoidal intensity amplitudes. The contrast of the experimental data can then be defined as the ratio of the amplitude to the average intensity. Consider a focus on the 450 to 750 nm range, since the sinusoids are not well defined at the long wavelength limit. The calculated contrast values for the samples with and without interfacial nanostructures are plotted in FIG. 10. The simulation models for fabricated nanostructure, planar, and ideal linear taper are shown, with the measured interference contrast for thin polymer film on fused silica substrates with nanostructured and planar interfaces. The theoretical contrast values predicted using RCWA are also plotted. For the nanostructured interface samples, the structure profile was estimated from the SEM images. The planar samples were modeled as a semi-infinite silica substrate with a thin homogeneous polymer layer, allowing for the calculation of the thin-film interference. The substrate thickness in both cases was assumed to be longer than the coherent length of the light source, therefore the reflection orders at the back side of the substrates do not interfere. The reflection efficiencies were modeled using Fresnel equations to account for the losses in the theoretical transmission. A third model with linear taper profile was also included, demonstrating that further interference mitigation is possible with improved nanostructure profiles.

The experimentally measured contrast data for both planar and nanostructured interfaces fit well to the simulation models. These results indicate that the interference contrast of the samples with interfacial nanostructures can be reduced roughly by a factor of two compared to those without. The suppression of interference effects can also be observed at both incident angles of 0° and 30°. The simulation result also shows that with improved nanostructure height and profile, the contrast can be reduced further by a factor of 10. These results indicate that interfacial nanostructures are effective to suppress the interference effect, which can eliminate iridescent appearance and wavelength/angle-dependent transmission.

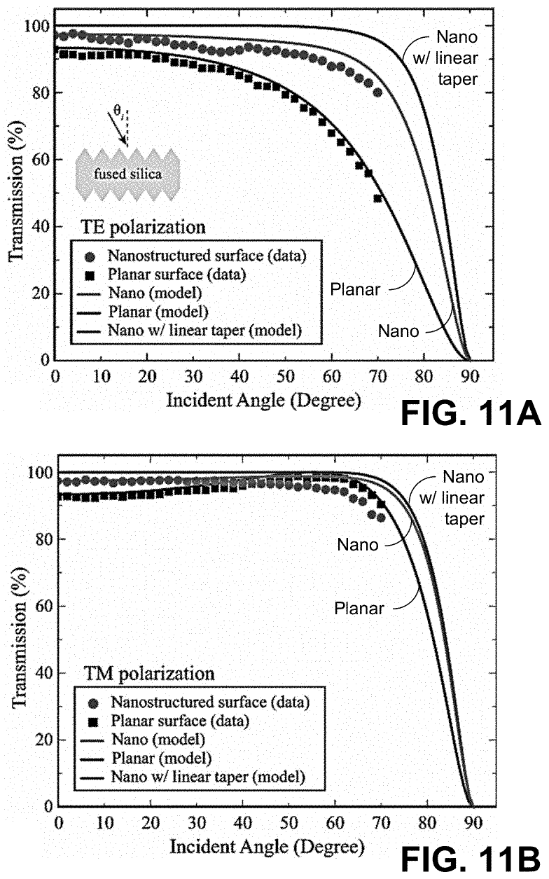

Going beyond the suppression of thin-film interference, the interfacial nanostructures can also improve light transmission. To demonstrate this, first the transmission of the double-side patterned silica substrate was characterized using a 633 nm HeNe laser (e.g., Model 30995, Research Electro-Optics, Inc.). A rotation stage was used to rotate the sample to change the incident angles from 0° to 70° with 1° resolution. For incident angles larger than 70°, the illumination area exceeds the area of the nanostructures material, and therefore were not considered. A photodiode detector (e.g., Model 918D-UV-OD3, Newport Co.) was used to measure the transmitted light intensity. The transmission for both TE and TM polarizations were characterized. The specular transmission measurements and theoretical simulation model of a single fused silica substrate with and without double-side patterned nanostructures under different incident angles are plotted for TE and TM polarization in FIGS. 11A and 11B, respectively. It can be observed that the data agree well with the RCWA and Fresnel models for the samples with and without the nanostructures, respectively. For TE polarization, the transmission was enhanced by about 5% near normal incidence, and up to 20% in a 60-70° incident angle range. For the maximum incident angle of 70° , the measured transmissions for the samples with and without the nanostructures were 80% and 48%, respectively. However, the optical transmission of the nanostructured sample is lower for TM polarization between a 50-70° incident angle range. This may be attributed to the Brewster angle effect, where the transmission for the planar sample is 100%. The nanostructured sample, in comparison, has scattering losses due to fabrication defects. The measurement error range is within 1.5% based on multiple measurements.

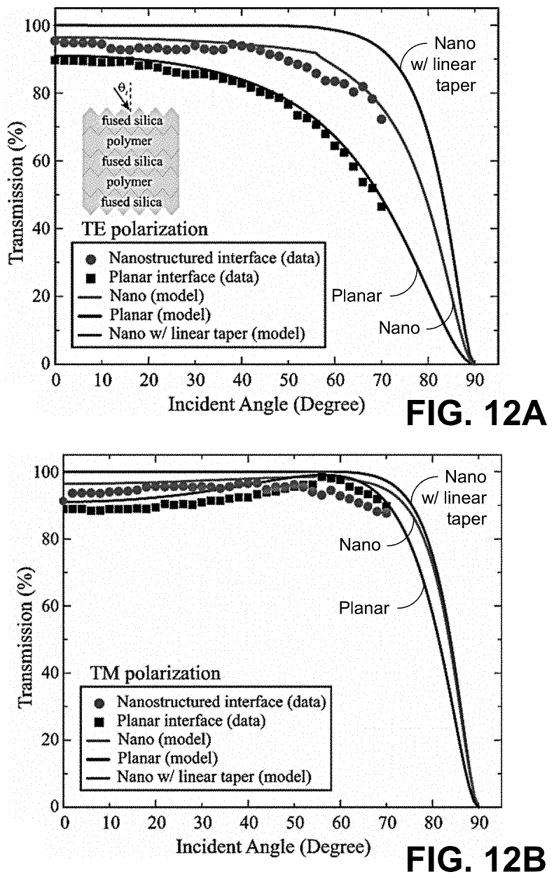

The measured transmission and theoretical calculations for the thick 3-layer silica-polymer composite with and without the interfacial nanostructures are shown in FIGS. 12A and 12B. The specular transmission measurements and simulation under different incident angle for a thick 3-layer silica-polymer multilayer composite with and without interfacial nanostructures are shown for TE and TM polarization, respectively. The sample was fabricated by bonding three double-side patterned fused silica substrates with two epoxy layers, as illustrated in the inset diagram. In this case the theoretical models assume no interference occurs since the layers are thick, therefore the transmissions at the interfaces were simulated separately and multiple together to yield the total transmission. The experiment results show that under illumination with TE polarized light, the transmission is enhanced by 7% at normal incidence, and up to 30% at 60-70° incident angle ranges. For the maximum incident angle of 70°, the measured transmission for the composite with and without the nanostructures are 72% and 46%, respectively. For TM-polarized light similar enhancement for the planar interface sample can be observed due to Brewster angle, while the transmission for the nanostructured interface sample reduces monotonically at increasing incident angles. The measurement error bar is within 1% based on multiple measurements. The simulation model also demonstrates that near-perfect transmission can be maintained at highly oblique incident angles for taller interfacial nanostructures with a more effective tapper profile for both polarizations.

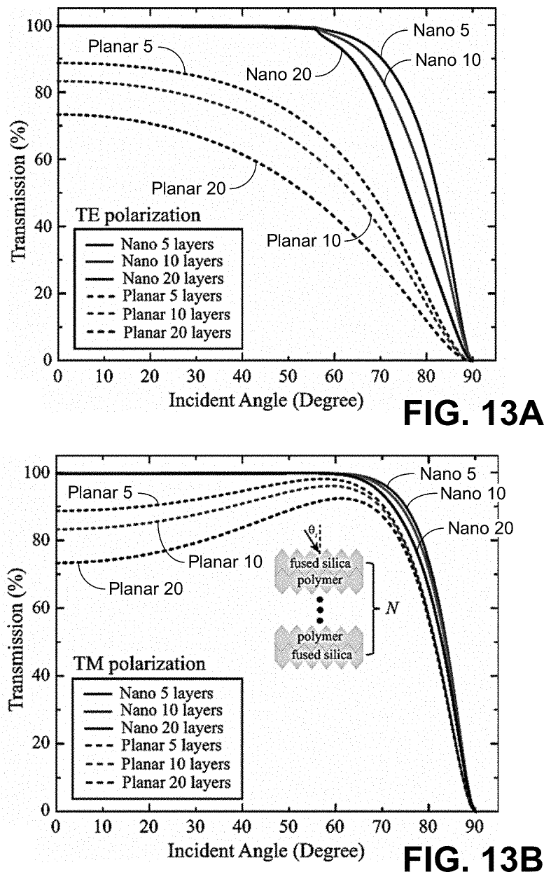

It is important to note that the transmission enhancement for 3 layers is not significant due to the relatively similar index of fused silica and epoxy used. However, the improvement would be significant at higher number of layers (N). The theoretical transmission for 5, 10, and 20 layers with planar and nanostructured interface are plotted in FIGS. 13A and 13B, which illustrate significant enhancement. Specular transmission simulation under different incident angles for 5, 10, and 20 layers thick silica-polymer composite with and without interfacial nanostructures are shown for TE and TM polarization, respectively. The nanostructure was modeled to have 750 nm height with a linear taper profile. The transmission of the sample with planar interface degrades significantly. However, the transmission can be maintained at near unity even at high incident angles for the corresponding composite with interfacial nanostructures. These results demonstrate that the interfacial nanostructures are effective in suppressing the reflection at the multiple polymer-silica interfaces to enhance overall transmission. Enhancement in more number of layers would yield higher transmission enhancement.

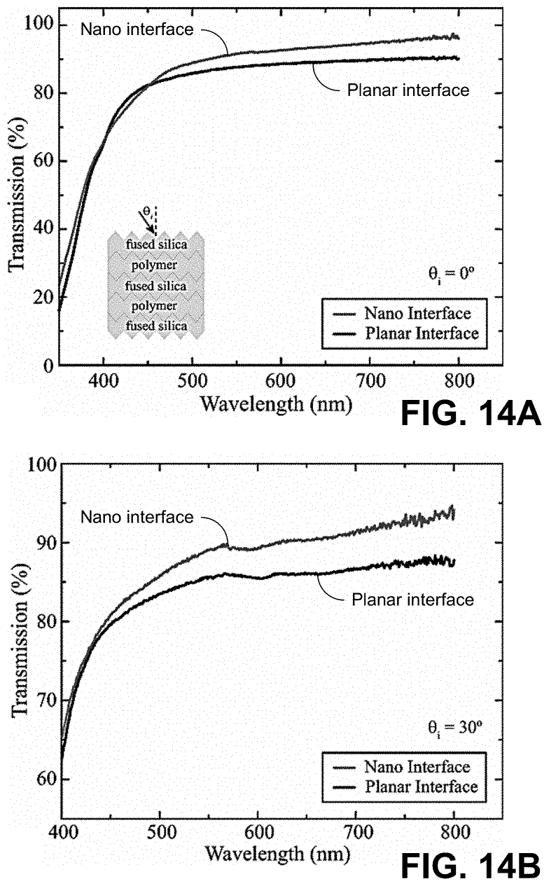

The broadband specular transmittance of the thick 3-layer silica-polymer multilayer composite with and without the nanostructures at the interfaces were also characterized at normal incidence (0°) and 30° incident angle, as shown in FIGS. 14A and 14B, respectively. Here it can be observed that the transmission across broad wavelength band can be enhanced. From FIG. 14A, the measurement data illustrates that up to 7% enhancement can be observed at 450 nm to 800 nm wavelengths, with a peak transmission of 97% compared with 90% without the nanostructures. The enhancement is reduced at wavelengths below 450 nm, and the transmission of the two samples are similar. This can be attributed to the relatively large structure period of 250 nm, which means diffracted orders in the UV can exist in the higher index polymer. The UV-curable epoxy also absorbs in the UV, therefore reducing transmission for both samples. From FIG. 14B, it can be observed that the transmission enhancement at 30° incident angle is up to 8%, with a peak transmission of 95% compared with 87% without the nanostructures. This is in reasonable agreement with the simulated models. Additional losses can be attributed to fabrication defects which has a larger footprint for off-axis illumination. The transmission data illustrate that the interfacial nanostructures work for broadband range and higher incident angle as predicted by the models. Note the thickness of the fused silica and epoxy layers are approximately 0.5 mm and 0.1 mm, respectively, but some variations in the epoxy can occur during the bonding process. Due to the relative thick layers, thin-film interference effects are not observed. However, interference effects can still be present if the multilayer composites are under illumination from a light source with higher coherence.

These results and the derived models indicate that by using interfacial nanostructures, the reflection between two materials can be successfully suppressed. This effect in turn suppresses interference in multilayer composites, allowing for wavelength and angle-independent optical behavior. For better interfacial antireflection effects than those demonstrated, taller structures with an optimal taper profile can be used. While the experimental data follow the trends predicted by the RCWA and Fresnel equation, errors can be observed. This may be attributed to the defects of the nanostructures. The proposed fabrication methods based on IL and RIE can be scalable, and full wafer patterning is possible. However, the defect areas from multiple samples can compound after bonding, resulting in scattering losses. This may lead to the transmission enhancement being slightly lower than theoretical models. However, the overall agreement between the data and theoretical model demonstrates that the interfacial nanostructure can enhance transmission of multilayer composite.

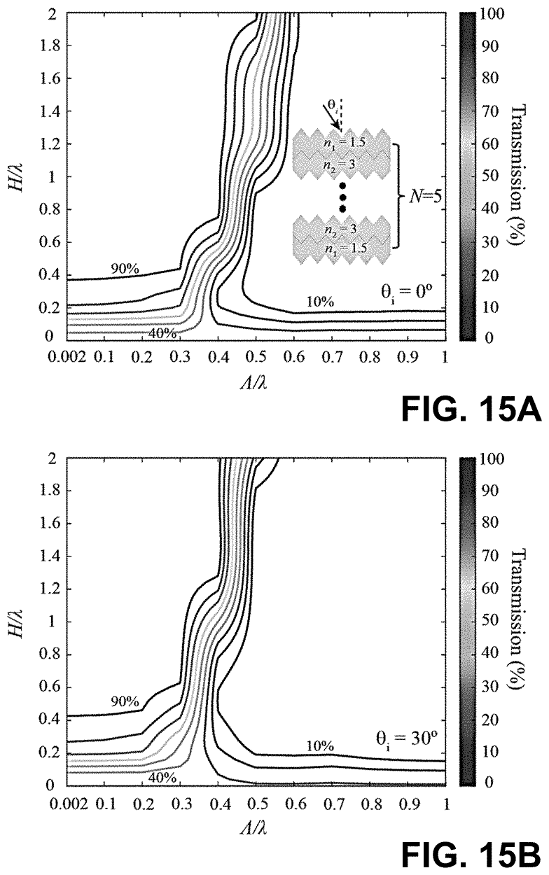

The experimental demonstration of this work is focused on the transmission enhancement between polymer and silica, which has relatively low reflection losses. The proposed interfacial nanostructures can even be more effective for higher index materials that are often used in optoelectronics, such as Si, Ge, and GaAs. Using the validated multilayer RCWA model, the transmission can be studied for a five-layer composite (N=5) with higher index mismatch (n₁=1.5 and n₂=3) versus normalized interfacial nanostructure height and period. FIGS. 15A and 15B show simulated 2D contour plots of the specular transmission in the 5-layer composite. The transmission efficiency is plotted versus normalized structure height and period at incident angles of θᵢ=0 ° and θᵢ=30°, respectively. Note only the zeroth-order specular transmission is considered, and any diffracted light is considered to be losses. Here it can be observed that the transmission of the composite with planar interfaces is 35.9% at normal incidence, corresponding to H=0 in FIG. 15A. The transmission can be enhanced to 94.4% for structure height H =0.6 λ and period A=0.3 λ. Note that since the light wavelength in a higher index medium reduces, a smaller interfacial nanostructure period is required to ensure subwavelength operation. As the structure height increases to H=2 λ at the same period, the transmission can be further enhanced to 99.8%. At incident angles θᵢ=30°, the transmission of planar sample is 30.6%, demonstrating higher losses. The transmission can be enhanced to 88.5% and 99.7% for structure heights of H=0.6 λ and H=2 λ, respectively, both with period A=0.3 λ.

One interesting phenomenon that can be observed is that for structures with larger period, the transmission drops dramatically. This can be observed for any structures with constant H, where the transmission decreases as the period increases. This can be attributed to the diffraction effect for large period. This then shifts the efficiency of the zeroth-order, dramatically decreasing the specular transmission. From these results, it can be concluded that a period smaller than 0.3 λ ensures subwavelength operation. However, reducing the period further does not result in any transmission enhancement, and is only useful for lowering the operating wavelength range. In addition, higher nanostructures also result in better transmission enhancement for a constant period. However, the enhancement is incremental and may not justify the higher fabrication cost. These results demonstrate that interfacial nanostructures are an effective way to enhance transmission in composite with higher index mismatch, which can improve the performance of nanophotonic devices, solar cells, and solid-state lighting.

While the experimental data followed the trends predicted by the RCWA and Fresnel equation, there are mismatches in some areas. This may be attributed to defects in the nanostructures. The interfacial nanostructures can be patterned and etched with a fairly large area. However, defect areas from multiple samples can be compounded after bonding, resulting in scattering losses. This may lead to the transmission enhancement being slightly lower than theoretical results. However, the existence of these mismatches does not prevent demonstration of the transmission enhancement of multilayer composites with interfacial nanostructure, which is the main focus of this disclosure.

The broadband measurements (using the UV-NIR spectrophotometer Cary 5000, Agilent Co.) indicate transmission can be enhanced across broad wavelength band. The measurement data illustrate that up to 5% enhancement can be observed at 450 nm to 800 nm wavelength at incident angles of 0°. In addition, up to 15% enhancement can be observed at higher incident angles of 60°. The transmission results drop down around from about 350 nm to about 600 nm. This may be attributed to some polymer composite thin film, which remained on the nanostructure surface. Transmission oscillations can be observed for the planar interface samples, which is heavily suppressed by the nanostructures. This effect in turn suppresses thin film interference, allowing for wavelength optical behavior.

In this disclosure, a rigorous optical design of interfacial nanostructure in multilayer materials was presented to enhance transmission and suppress interference effects. The simulation model was based on rigorous coupled-wave analysis (RCWA). The multilayer composites experiment results show the transmission was enhanced by about 10% near a 0° incident angle, and up to 20-30% in a 60-70° incident angle range under TE mode. The broadband transmission of the multilayer composites with interfacial nanostructures were measured. The transmission enhancement was up to 5% at 450 nm to 800 nm wavelength at incident angles of 0°, and up to 15% enhancement can be observed at higher incident angles of 60°. As a result, tapered nanostructures can be an effective method to emulate such a medium, and can reduce reflection losses, increase transmission, and suppress iridescence. This can mitigate wavelength/angle-dependence and enhance broadband transmission in multilayers. Fabrication techniques may be improved to acquire taller tapered nanostructures and higher yield to achieve higher transmission and lower losses.

Different mask materials can be used to fabricate taller interfacial nanostructures with heights over 700 nm for better AR effects at longer wavelengths and more oblique incident angles. Interfacial nanostructures with shorter periods less than 200 nm may reduce the diffraction and therefore improve the optical transmission in UV region. The profile of the structure can also be fine-tuned to obtain a wider range of tapered width. The yield can also be improved to reduce scattering losses and further enhance transmission. In addition, composite samples with more layers may be scalable and achieve higher transmission enhancement. The nanostructured interface may also exhibit novel mechanical and thermal properties.

This disclosure has demonstrated that interfacial nanostructures in multilayer composite stacks can reduce interfacial reflections, suppress interference effects, and enhance light transmission. This is supported by experimental characterization and theoretical modeling of light transmission in thin and thick multilayer films comprising a nanostructured interface between neighboring silica and polymer layers. The experimental data show that the interference contrast observed in the transmittance of thin films can be suppressed by a factor of two, and thick 3-layer silica-polymer composites can exhibit transmission enhancement up to 30% at a 60-70° incident angle range. From the experimental results, the enhancement is broadband and is effective at higher incident angles, and the fabricated interfacial nanostructures show higher transmission from 450-800 nm wavelength. The interfacial nanostructure can result in higher transmission enhancement for composites with higher refractive index mismatch, which has been examined using the validated RCWA models. It has been demonstrated that interfacial nanostructures can reduce reflection losses in multilayers composites, increasing transmission and suppressing iridescence. This can mitigate wavelength and angle-dependence behaviors and enhance broadband transmission in multilayers photonic element and devices.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims. therefore, at least the following is claimed:

1. A multilayer nanostructure, comprising:
a plurality of layers that comprise:
a substrate having a first surface and a second surface; and
tapered nanostructures formed on the first surface and the second surface of the substrate;
wherein adjacent layers of the plurality of layers are bonded together by a bonding material, forming a multilayer composite material having tapered nanostructures embedded at each interface between the adjacent layers and the bonding material.

2. The multilayer nanostructure of claim 1, wherein the substrate comprises fused silica patterned with an antireflection structure.

3. The multilayer nanostructure of claim 1, wherein the tapered nanostructures have a period of about 250 nm to about 400 nm.

4. The multilayer nanostructure of claim 1, wherein the tapered nanostructures have a height of about 300 nm to about 400 nm.

5. The multilayer nanostructure of claim 1, wherein the plurality of layers each have a thickness of about 600 to about 650 nm.

6. The multilayer nanostructure of claim 1, wherein the tapered nanostructures have a conical profile.

7. The multilayer nanostructure of claim 1, wherein the bonding material is a polymer.

8. The multilayer nanostructure of claim 1, wherein the substrate is a silica substrate or a sapphire substrate.

9. A method of making multilayer nanostructures, comprising:
patterning at least one surface of a first substrate with an antireflection coating and a polymer;
etching the polymer to form tapered nanostructures on the at least one surface of the first substrate to form a first layer;
bonding the first layer to a second layer comprising tapered nanostructures on at least one surface of a second substrate with a bonding material to form a multilayer composite material having tapered nanostructures embedded at an interface between the first layer and the bonding material and at an interface between the second layer and the bonding material.

10. The method of claim 9, wherein the first layer comprises the tapered nanostructures on a first surface of the first substrate and the tapered nanostructures on a second surface of the first substrate opposite the first surface.

11. The method of claim 10, wherein the polymer is etched to form the tapered nanostructures on the first surface prior to forming the tapered nanostructures on the second surface.

12. The method of claim 11, comprising spin coating a second thin film polymer onto the tapered nanostructures on the first surface prior to forming the tapered nanostructures on the second surface.

13. The method of claim 9, wherein the bonding material is a polymer.

14. The method of claim 13, wherein the polymer is an optical adhesive.

15. The method of claim 13, wherein the polymer is slow cured under ultraviolet (UV) light.

16. The method of claim 9, wherein the first and second substrates comprise a silica substrate, a sapphire substrate, or a combination thereof.
